(19) United States
(12) Patent Application Publication
(10) Pub. No.: US 2005/0039407 A1
(43) Pub. Date: Feb. 24, 2005

(54) Maid's window aid

(76) Inventor: George B. Atkisson, Vienna, VA (US)

Correspondence Address: George B. Atkisson, 10194 Hillington Court, Vienna, VA, 22182, US

(21) Appl. No.: 10/914,673

(22) Filed: Aug. 10, 2004

Related U.S. Application Data
(60) Provisional application No. 60/496,712, filed on Aug. 21, 2003.

(51) Int. Cl. E05D 15/20

(52) U.S. Cl. 49/449

(57) ABSTRACT

A window accessory which allows a user to push against the sides of a window casing in order to pivot a window out of the casing for cleaning or other tasks. The AID has a pair of telescoping members which can be held in a variety of positions and one of the members has. another member pivoted thereto. The aid is positioned in a window casing with the pivoted member at an angle to the other members and pressure is brought down on the Aid to straighten the angled member which pushes out the sides of the window.

Most contemporary tilt-in windows stick and are hard to raise. Once raised they are hard to tilt in for washing or replacement as they are advertised and intended.

It is suggested and anticipated by the manufacturer that one hand reaches over and pushes the sash liner in while the other hand pulls out on the window sash in a twisting motion. This can not work well because the opposing sash liner does not release the other side. Thus, even if the one side comes out the window is twisted and can be damaged. Many windows are twisted until it causes damage to the seal.

Consequently, when the window fogs up the owner and/or the manufacturer is subjected to replacement cost. Even if no damage results it is still difficult and unwieldy (especially for the elderly or female maid) to remove or tilt-out the window. Reaching over a kitchen counter or open a window is very difficult for anyone. One, after inserting the WINDOW MAID'S AID, is able to pull the lower window sash out with one hand without raising the sash.-even if it is stuck. After having tilted in the lower sash, the upper sash is more accessible and may be loosened and tilted in if stuck by inserting the AID. When the AID is left in place and the window is washed it can be returned undamaged with one hand to its original position.

There are two ways to adjust the AID to accommodate different width windows:

1/lay the AID on the top of the sash. Slide PART C out until the ends of the AID are against each sash liner. Take your left hand and place your thumb nail where part C and B meet. extend PART C out 1/2 inch or to where a number appears and secure it in place by turning the set screw PART F until it is tight.

2/the second way to adjust the AID for use is to measure the distance between the sash liners; i.e., 24, 26 or 34 and use the markings on PART C.

To use the AID after having made the necessary adjustment; while holding it with both hands, collapse it slightly until it will fit against the opposing sash liners and slowly push down taking care to keep both ends level with each other and the AID is locked in place. This action will push each liner back ¼ of an inch. Clasp the middle of the window sash and pull it straight out.

### Making the Aid

PART A—3/4 inch aluminum channel 15 inches long.

PART B—3/4 inch aluminum square pipe cut at 45 degree angle at one end, 15 inches long.

PART C—3/8 inch aluminum channel 14 & 1/2 inches long.

PART D—one 8-32 machine screw 1 inch long with one locking cap nut and one internal tooth lock washer. Rivet can be used if dismantling is not intended.

PART E—one steel strip 5/16 inches wide & 1/4 inch thick, bent in a U shape and taped to ¼-20 thread. Other means would suffice; i.e., square nut with thin clip on tip to assist in assembling.

PART F—one ¼ 20 hex head machine screw 1 inch long with head dipped in Plasti Dip paint.

PART G—dip one end of parts A, B, and C in rubberized paint, Plasti Dip or suitable substitute.

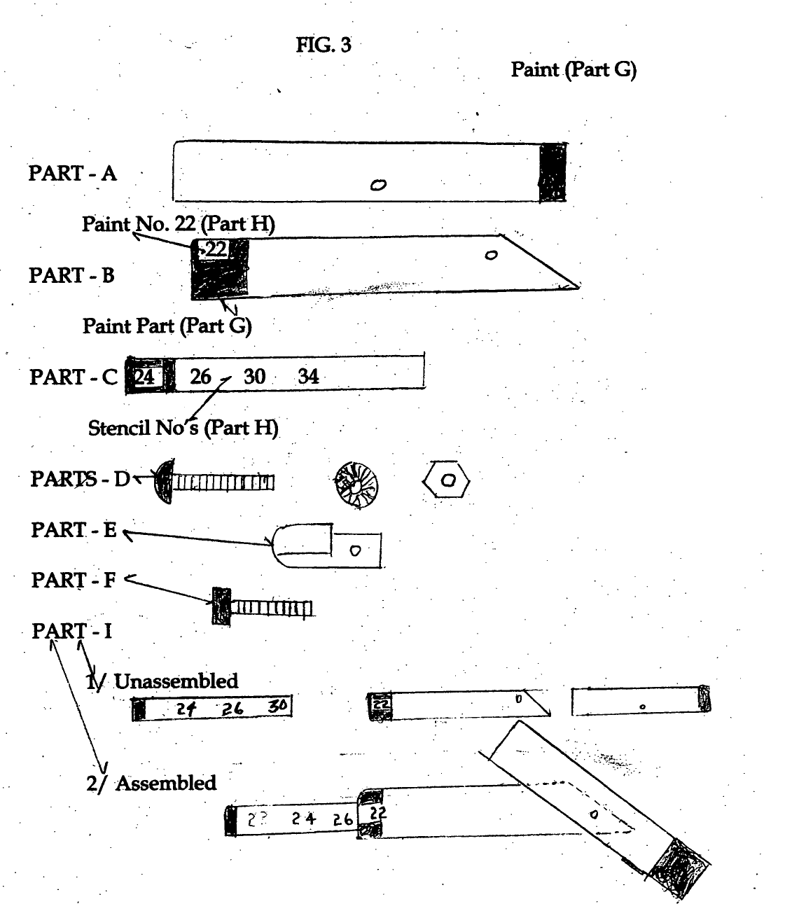

PART H—stencil the numbers 24, 26, 30 and 34 on PART C, as depicted in FIG. 3 at appropriate intervals to assure proper length of AID. The number 22 should be stenciled on the end of PART B.

PART I—join PART A to PART B by laying B on a bench with long side down. Temporarily place a shim strip 1/8 inch thick on B. Then place A down over B. Clamp at a combined length of 22 & 1/2 inches and drill a hole to accommodate an 8-32 machine screw 1/4 inch each way as depicted in FIG. 3. Unclasp and insert # 8-32 machine screw, washer and locking nut.

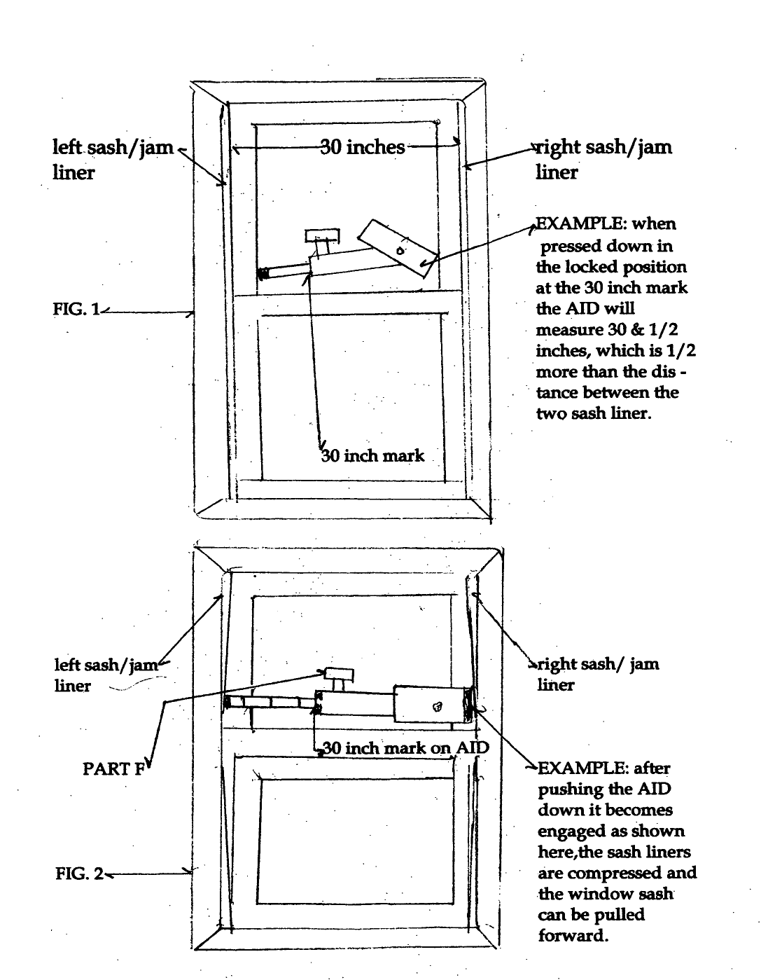

1. What I claim as my invention is: a device that has one adjustable part and one pivoting feature that allows the user to insert the MAID'S WINDOW AID in between the window sash liners FIG. 1 Page 6. When the device is pressed downward and locked in place the sash liners are compressed to allow pivoting the window sash forward for washing or replacement as indicated in FIG. 2 Page 6.
By loosing Part F Page # 6, Part C Page # 5 can be adjusted to accommodate various window widths by tightening Part F to where it is stationary. Once the window is washed or replaced it can be pivoted back in place. The AID can be released for further use by turning Fart F counter-clock-wise which loosens the device.
I claim that the AID is a device that can be used to free windows that are stuck by inserting it as indicated above. It is of light weight and can be stored in the household conveniently.
